(19) United States
(12) Patent Application Publication
(10) Pub. No.: US 2015/0100878 A1
(43) Pub. Date: Apr. 9, 2015

(54) METHOD AND SYSTEM FOR RENDERING A WEB PAGE

(71) Applicants: Ian Tinkham McCabe Flanigan, Zurich (CH); Brian Stoler, San Mateo, CA (US); Daniel Felix Pupius, San Francisco, CA (US)

(72) Inventors: Ian Tinkham McCabe Flanigan, Zurich (CH); Brian Stoler, San Mateo, CA (US); Daniel Felix Pupius, San Francisco, CA (US)

(73) Assignee: GOOGLE INC., Mountain View, CA (US)

(21) Appl. No.: 13/489,353

(22) Filed: Jun. 5, 2012

(51) Int. Cl. G06F 17/22; G06F 17/00

(52) U.S. Cl. CPC G06F 17/2247
USPC 715/235

(57) ABSTRACT

A system and method for rendering and serving a web page. A style sheet is requested and a style sheet in a response is received from a server. A cutpoint associated with the style sheet is identified. The style sheet is split into a plurality of derived style sheets based on the identified cutpoint, and the web page is formatted based on the plurality of derived style sheets.

### BACKGROUND

1. Field

The present disclosure generally relates to web pages, and more particularly to rendering and/or serving web pages.

2. Description of the Related Art

Some current web pages use cascading style sheets to enhance the appearance of a web page. Some web browsers limit the size of style sheets; thus, errors typically occur when formatting a web page with a style sheet that exceeds a web browser's size limit.

### SUMMARY

The disclosed subject matter relates to rendering a web page. The method includes requesting a style sheet from a server and receiving the style sheet from the server. The method may also include identifying a cutpoint associated with the style sheet and splitting the style sheet into a plurality of derived style sheets based on the identified cutpoint. The method additionally provides for formatting the web page based on the plurality of derived style sheets.

The disclosed subject matter further relates to a method of serving a web page that includes identifying a cutpoint associated with a style sheet based on a maximum number of rules for a web browser. The method further includes sending the web page to the web browser in response to a web page request from the web browser, wherein the web page includes code capable of causing the web browser to request the style sheet. The method additionally includes sending the style sheet and the identified cutpoint to the web browser in response to a style sheet request wherein the code included in the web page is further capable of causing the web browser to split the style sheet into a plurality of derived style sheets based on the identified cutpoint and format the web page based on the plurality of derived style sheets.

The disclosed subject matter further relates to a system for providing for rendering a web page. The system includes one or more processor(s) and a memory containing processor-executable instructions. When executed by the processor(s), the system requests a style sheet from a server, receives the style sheet from the server, and identifies a cutpoint associated with the style sheet, wherein the cutpoint is identified as a character offset within the style sheet. The system also splits the style sheet into a plurality of derived style sheets based on the identified cutpoint and formats the web page based on the plurality of derived style sheets.

The disclosed subject matter also relates to a machine-readable storage medium comprising machine-readable instructions for serving a web page. The method includes identifying an indicator associated with a style sheet, wherein the indicator is associated with a variation of the style sheet for a web browser, writing the indicator to a header of a response to a style sheet request, and sending a web page to the web browser in response to a web page request from the web browser. The web page includes code capable of causing the web browser to request the style sheet. The method further includes sending the style sheet and the identified indicator to the web browser in the response to the style sheet request, wherein the code included in the web page is further capable of causing the web browser to re-write rules of the style sheet into a derived style sheet based on the identified indicator and format the web page based on the derived style sheet.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example system for rendering and/or serving a web page.

FIG. 2 is a block diagram illustrating an example client and server from the system of FIG. 1.

FIG. 3a illustrates an example process for rendering a web page.

FIG. 3b illustrates an example process for serving a web page.

FIG. 4a is a flow diagram illustrating an example process for serving and/or rendering a web page.

FIG. 4b is a flow diagram illustrating an example process for serving and/or rendering a web page.

FIG. 5 is a block diagram illustrating an electronic system with which some implementations of the subject technology are implemented.

### DETAILED DESCRIPTION

In the following detailed description, numerous specific details are set forth to provide a full understanding of the subject technology. It will be apparent, however, that different aspects of the subject technology may be practiced without some of these specific details. In other instances, well-known structures and techniques have not been shown in detail so as not to obscure the disclosure.

The disclosed subject matter describes systems and techniques for rendering a web page. A cascading style sheet may be referenced by a web page. When the web browser loads the web page, the web browser may request the style sheet from a server. The server may identify one or more cutpoints associated with the style sheet based on a size limit or maximum number of rules per style sheet for the requesting web browser. Identification of a cutpoint by a server may include identifying a cutpoint by analyzing the contents of the style sheet and associated data for a cutpoint value that has already been generated and identifying a cutpoint by generating a cutpoint location based on the contents of the style sheet and associated data. Identification of a cutpoint may also be identified by a client. Identification of a cutpoint may include identifying a cutpoint value that was transmitted by the server and may also include identifying a cutpoint by generating the cutpoint location based on the contents of the style sheet and associated data.

The term “cutpoint” as used herein encompasses its plain and ordinary meaning, including, but not limited to a location at which a style sheet will be split into separate style sheets. The style sheets resulting from such a split may be called derived style sheets. The cutpoint is located such that no rule will be split between derived style sheets. A cutpoint may consist of a character offset or any other representation of a character offset, including, but not limited to ASCII, hexadecimal, octadecimal, decimal, or binary. A cutpoint may consist of a comment or a marker that is placed within the style sheet in the location at which the style sheet is to be split. The server may identify the cutpoint prior to a request for the style sheet, prior to a request for the web page, after a request for the style sheet, or after a request for the web page. References to “cutpoint” in the singular contained in this description are not intended to mean “one and only one” unless specifically so stated, but rather “one or more.” The cutpoint may preexist as a portion of the style sheet or may be determined by the web browser of a client. The server may send the style sheet to the web browser with the cutpoint in response to a request for a style sheet. Alternatively, the web browser may access the style sheet and associated cutpoint from cache if the style sheet has been previously sent to the client by a server. Instructions in the web page may cause the web browser to split the style sheet into multiple derived style sheets based on the cutpoint. The web page is then formatted based on the multiple derived style sheets.

The server may identify one or more indicators associated with the style sheet that indicates a variation of the style sheet for use with a web browser. The style sheet may be rewritten based on the requesting web browser. The term “indicator” as used herein encompasses its plain and ordinary meaning, including, but not limited to, any character or other content that is associated with a variation that may be made to the style sheet for use with a web browser.

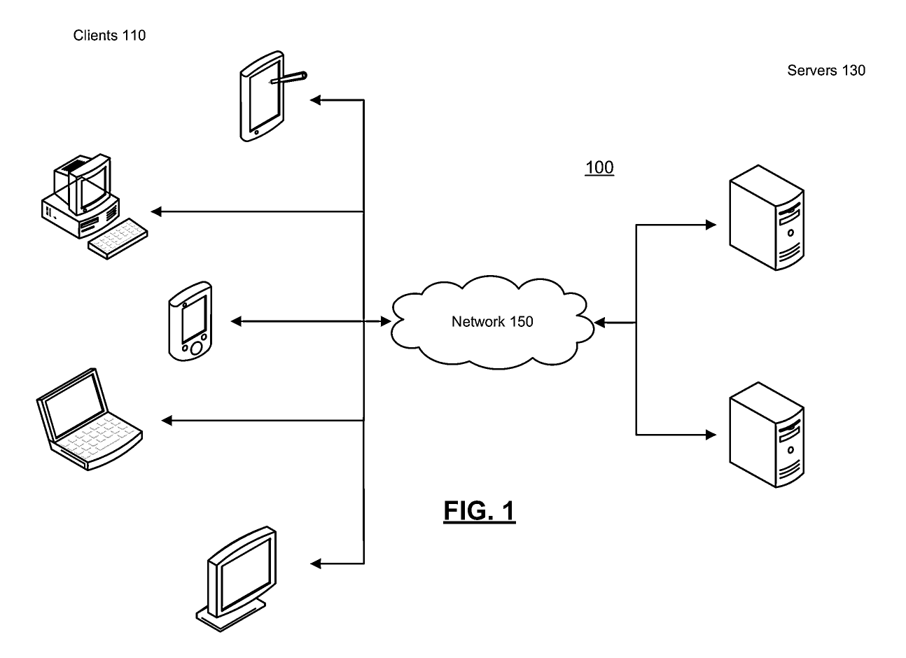

Turning to the drawings, FIG. 1 illustrates an example system 100 for rendering and/or serving a web page. The system 100 includes clients 110 and servers 130 connected over a network 150.

The system 100 is comprised of client(s) 110, server(s) 130 and the network 150 in any combination or configuration that allows for the rendering of a web page, including implementations with multiple servers 130. Each of the clients 110 can be, for example, desktop computers, laptop computers, mobile devices (e.g., a smartphone, tablet computer, or PDA), set top boxes (e.g., for a television), video game consoles, or any other devices having an appropriate processor, memory, and communications capabilities. In certain instances, different versions and/or configurations of the system that include subject technology as disclosed herein are available for download from a server 130 and subsequent installation on client 110. The servers 130 can be any device having a processor, memory, and communications capability for hosting the data for installing and hosting the system. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a ring network, a mesh network, a star-bus network, tree or hierarchical network, and the like.

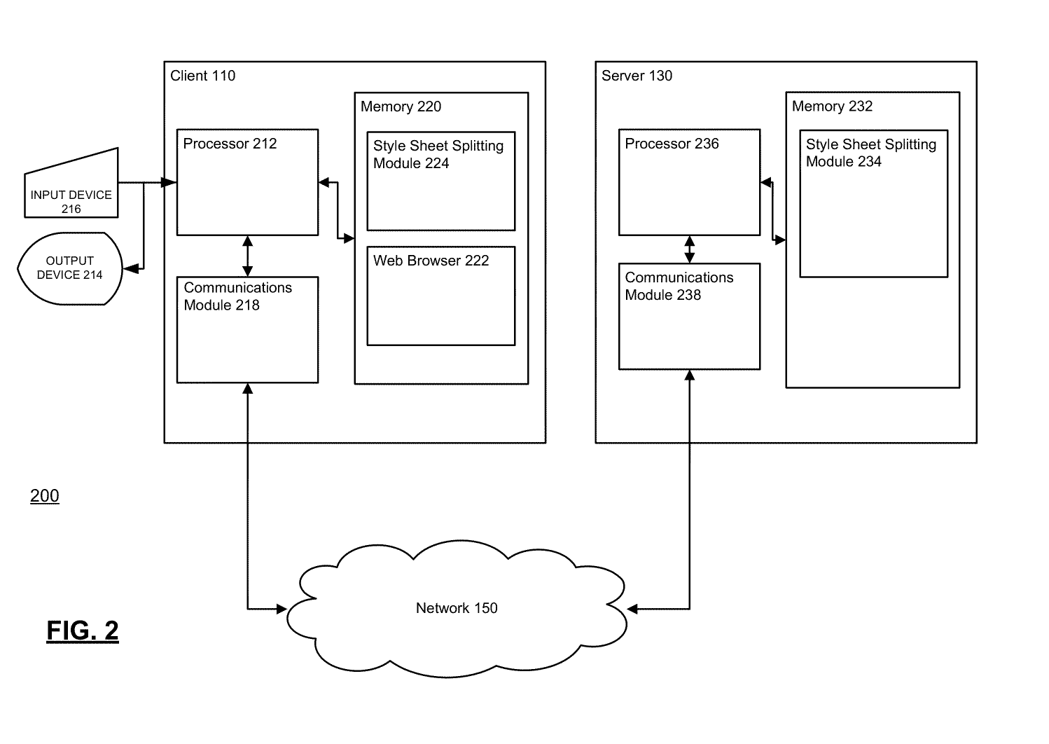

FIG. 2 is a block diagram illustrating an example client and server from the system 100 of FIG. 1. The client 110 and the server 130 are connected over the network 150 via respective communications modules 218 and 238 and are configured to interface with the network 150 to send and receive information, such as data, requests, responses, and commands to other devices on the network. The communications modules 218 and 238 can be, for example, modems or Ethernet cards.

The client 110 includes a processor 212, a communications module 218, and a memory 220 that may include a style sheet splitting module 224 and web browser 222. Web browser 222 may include style sheet splitting module 224 or the style sheet splitting module 224 may be a separate module within memory 220.

The processor 212 of the client 110 is configured to execute instructions, such as instructions physically coded into the processor 212, instructions received from software in memory 220, or a combination of both. For example, the input device 216 may provide textual information to processor 212 which is processed by a web browser 222 stored in memory 220. The textual information may then be sent through network 150 via communications module 218 to server 130, which receives the information through communications module 238.

Server 130 includes a processor 236, a communications module 238, and a memory 232 that may include a style sheet splitting module 234.

Processor 236 is configured to execute instructions, such as instructions physically coded into the processor 236, instructions received from software in memory 232, or a combination of both.

Style sheet splitting module 234 may be capable of identifying one or more cutpoints in style sheets and additionally may be capable of writing the identified cutpoints to the style sheet itself, a packet associated with the style sheet, or a file associated with the style sheet. The style sheet splitting module 234 is additionally configured to support and respond to requests from web browser 222 contained in client 110.

Processor 236 processes information from style sheet splitting module 234 and sends information through communications module 238, through network 150, to client 110. Processor 212 then receives the information from processor 236, processes the information through style sheet splitting module 224 to be displayed on output device 214.

Services of style sheet splitting module 224 and style sheet splitting module 234 may differ. For instance, style sheet splitting module 224 of client 110 may provide services associated with detecting whether a cutpoint has been transmitted from a server 130, identifying a cutpoint for a specific web browser if no cutpoint was transmitted, splitting the style sheet into derived style sheets based on the cutpoint. Services of style sheet splitting module 234 of server 130 may include determining multiple cutpoints based on requirements of multiple web browsers for a single style sheet. Each group of cutpoints pertaining to a specific web browser may be stored in separate locations in the style sheet and/or associated data.

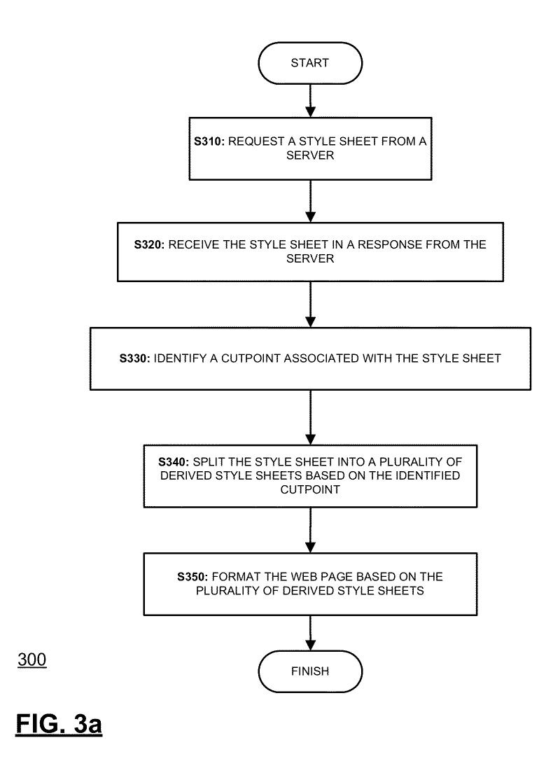

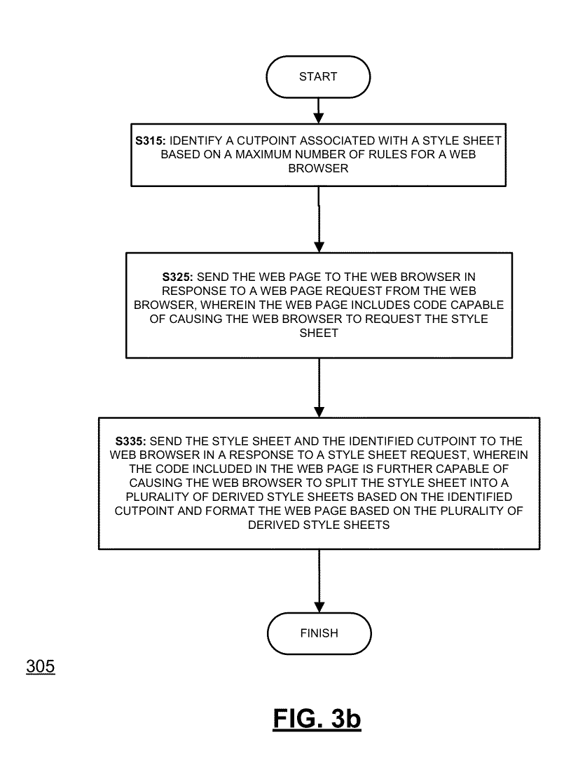

FIG. 3a illustrates an example process for rendering a web page as shown by the example client 110 and server 130 of FIG. 2 that can provide for rendering and/or serving a web page. Although process 300 of FIG. 3a is described with reference to FIG. 2, the process 300 is not limited to such a configuration and can be applied to other systems and configurations.

The process begins with step S310, when client 110 requests a style sheet from a server 130. The request for the style sheet may occur when a requested web page is to be rendered by the web browser 222 of client 110. The web browser 222 may be prompted to request the style sheet on the basis of a link or other request for a style sheet based on information contained in the web page. The request for a style sheet may originate from user input, such as a user entering a uniform resource locator (URL), or other identifier that allows for the provision of a web page. The request may additionally originate from client 110, by virtue of direction from a current web page.

In step S320, client 110 receives a style sheet from the server 130. The client 110 may receive the style sheet and the web browser 222 of client 110 may cache the style sheet including one or more cutpoints or other indicators that are associated with the style sheet for use with later requests for the same style sheet. A style sheet that has been previously received from server 130 including the cutpoints that are associated with the style sheet may be accessed from cache by the web browser 222 upon subsequent requests for the style sheet.

In step S330, client 110 identifies a cutpoint or other indicator associated with the style sheet. The cutpoint may be associated with the style sheet by being located in the header of the response to the style sheet request generated by the server 130. The cutpoint itself may comprise a character offset from the first character contained in the style sheet or may begin at any location within the style sheet.

The web browser 222 may identify the cutpoint associated with the style sheet based on code that is located in the web page. Upon identification of the cutpoint, the instructions coded in the web page may cause the web browser 222 to split the style sheet into multiple derived style sheets for use in rendering the web page. Upon identification of an indicator, the instructions coded in the web page may cause the web browser 222 to re-write the style sheet into a derived style sheet for use in rendering the web page.

Indicators may contain information that allow a style sheet to be rewritten based on the web browser that has made the request. Although some embodiments of the subject disclosure relates to splitting style sheets using cutpoints, other types of editing may cause the style sheet to be rewritten based on indicators. Such types of editing of the text of the style sheet may include but are not limited to removing, changing, or adding text to the style sheet, removing comment indicators from a string of text such that an additional rule is created, or any other edit to the text of the style sheet. An indicator may be identified in addition to a cutpoint, such that the style sheet is split into multiple derived style sheets based on the cutpoint and further re-written based on the indicator.

Multiple cutpoints may be associated with the style sheet. The cutpoint represents the location at which the style sheet should be separated into derived style sheets. The cutpoint may allow for each derived style sheet to contain a maximum number of rules per derived style sheet that may be handled by the web browser 222 without truncating each of the derived style sheets. By way of example, if the maximum number of rules that a web browser can handle is 4,096, then the cutpoint(s) associated with the style sheet will be established so that no single derived style sheet will contain more than 4,096 rules. If the style sheet contains less than 4,096 rules, no cutpoint is identified and the web page is formatted based on the style sheet without being split. Therefore, each (if any) set of nested rules in the style sheets contain the complete set of nested rules of the style sheet.

In the instance that there are nested rules in the style sheet, a cutpoint may not be identified such that a set of nested rules would be split between derived style sheets. The term “nested rule” as used herein encompasses its plain and ordinary meaning, including, but not limited to a rule belonging to a group of rules which apply to a particular aspect of the web page together. The cutpoint may be established so that the cutpoint is not placed directly or immediately before a nested rule in order to establish the cutpoint in a location that does not separate a nested group of rules between derived style sheets.

Nested rules may be considered as rules for the purposes of identifying the maximum number of rules that may be contained in a style sheet or derived style sheet. Nested rules that contain more than a maximum number of rules may not be split between derived style sheets, which may result in truncation of a style sheet upon transmission to the web browser of a client device. Nested rules may be grouped together and enclosed by delimiters such as curly brackets “{” and “}”. Accordingly, a cutpoint may be determined such that the location of the cutpoint does not fall between a single pair of any type of paired delimiters.

The location of the cutpoint may be determined such that the location of the cutpoint does not fall between a single pair of paired delimiters denoting a comment such as the paired delimiters “/*” and “*/”. The location of the cutpoint may also be determined such that the cutpoint does not fall in a single-line comment. The location of the cutpoint may be determined such that the cutpoint does not fall on a comment line identified by a single delimiter such as “//”.

The web page may then be formatted based on the derived style sheet(s). That is, the web page may be rendered so that the web page takes on the formatting and appearance dictated by the rules in the derived style sheets. The formatted web page may then be provided for display on an output device of client 110 for a user to view.

In step S340, client 110 splits the style sheet into a plurality of derived style sheets based on the identified cutpoint. If multiple cutpoints are identified, the style sheet is then split into a plurality of derived style sheets based on the multiple cutpoints. The client 110 may split the style sheet based on instructions using the cutpoint, such as code, that are written into the web page. Client 110 may re-write the style sheet into a derived style sheet based on the identified indicators. The client 110 may re-write the style sheet based on instructions using the indicators, such as code, that are written into the web page.

The process ends in step S350 when the client 110 formats the web page based on the derived style sheet(s). Because the number of rules in each derived style sheet that has been created based on cutpoints does not exceed a maximum number of rules for a style sheet as required by the web browser that is rendering the page, the derived style sheets may then be used to format the web page correctly, thus allowing the web page to be rendered using all formatting provided by the total rules comprising the derived style sheets.

FIG. 3b illustrates an example process 305 for serving a web page as shown by the example client 110 and server 130 of FIG. 2 that can provide for rendering a web page. Although process 305 of FIG. 3b is described with reference to FIG. 2, the process 305 is not limited to such a configuration and can be applied to other systems and configurations.

The process 305 begins with step S315, when a server 130 identifies a cutpoint associated with a style sheet based on a maximum number of rules for a web browser 222 of client 110. Step S315 is identified in FIG. 3b as occurring after the client 110 requests a web page from the server 130. However, this step may be performed prior to the web browser's request of the web page from server 130. The server may identify the cutpoint on the basis of a character offset in the style sheet. Multiple cutpoints may be identified that are associated with a single style sheet. The identified cutpoint may be stored by the server 130 in the header of the response sent by the server with the style sheet. The cutpoint may also be stored within the style sheet itself. Accordingly, the cutpoint may be stored in a comment within the style sheet or the cutpoint may consist of a marker placed within the style sheet at the location at which the style sheet is to be split. The server 130 may identify the cutpoint of the style sheet following the server 130's receipt of a request for the style sheet from the client 110. The cutpoint may then be written into the header of the server's response to the style sheet request or in a portion of the style sheet by server 130.

Cutpoints may be written into the header of the response, such as a Hypertext Transfer Protocol (HTTP) header of the response, while leaving the text of the actual style sheet unchanged. Thus, the same response may be used by multiple web browsers, including web browsers that do not have a limit to the number of rules for each style sheet.

Alternatively, the cutpoint may be identified during the initial generation of the style sheet or uploading of the style sheet to the server 130, and thus, comprise a portion of the style sheet. This may occur as an automated process or alternatively based on entry of a cutpoint by a web developer in the process of generating the style sheet. Cutpoints may be stored separately from the style sheet.

In step S325, server 130 sends the web page to the web browser 222 of client 110 in response to a web page request from the web browser 222, wherein the web page includes code which when executed by the web browser 222, causes the web browser 222 to request the style sheet from server 130.

The process 305 ends in step S335, when the server 130 sends the style sheet and the identified cutpoint to the web browser 222 of client 110 in response to a style sheet request from client 110, wherein the code included in the web page further causes the web browser 222 to split the style sheet into a plurality of derived style sheets based on the identified cutpoint and format the web page based on the plurality of derived style sheets.

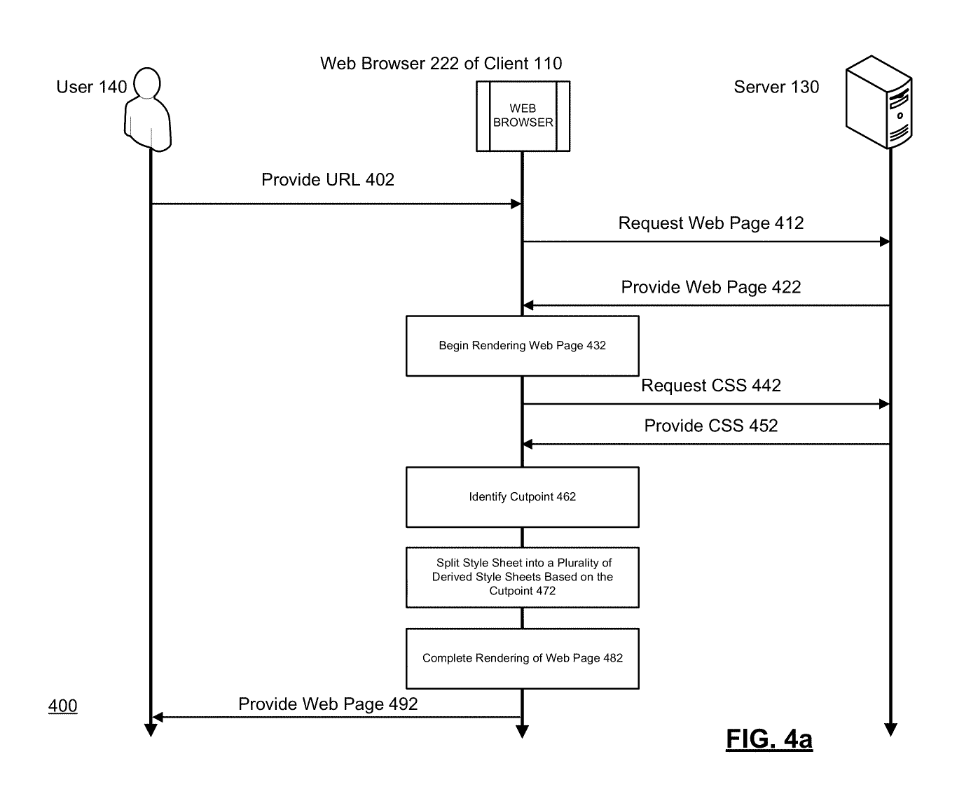

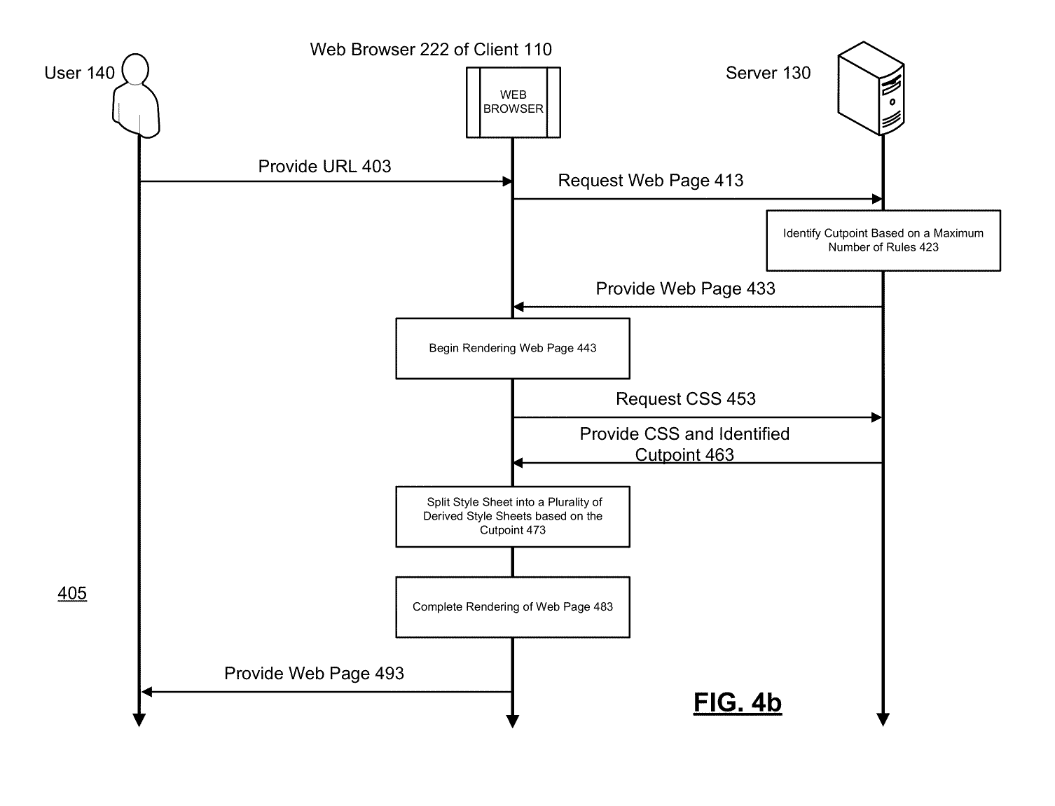

FIG. 4a is a flow diagram illustrating an example process for serving and/or rendering a web page. FIG. 4a illustrates an example flow process 400 for serving and/or rendering a web page as shown by the example client 110 and server 130 of FIG. 2 and a user 140 that can provide for rendering and/or serving a web page. Although process 400 of FIG. 4a is described with reference to FIG. 2 and is associated with some steps initially referenced in FIG. 3a, the process 400 is not limited to such configurations and processes and can be applied to other systems, configurations, and processes.

As shown in FIG. 4a, user 140 may provide a URL 402, or other identifier of a web page to client 110. The URL may be provided via an input device 216 of client 110 such as a keyboard. The URL may be provided to the client 110 by an input device 216 such as a mouse, by selecting a URL or a hyperlink of a web page that is being displayed to a user. A URL may additionally be provided in the form of a rerouted link from another URL.

The web browser 222 of client 110 may then request the web page 412 from server 130, and the server 130 provides the requested web page 422 to the web browser 222. The web browser 222 begins formatting or rendering the web page 432 and requests a cascading style sheet (CSS) 442 from server 130. Server 130 provides the CSS 452 to the web browser 222. The web browser 222 in conjunction with the style sheet splitting module 224 of client 110 then identifies a cutpoint 462, splits the style sheet into a plurality of derived style sheets based on the cutpoint 472, and then completes the rendering of the web page 482. The formatted web page is then provided for display 492 on an output device 214 of the client 110 for viewing by user 140.

FIG. 4b is a flow diagram illustrating an example process for serving and/or rendering a web page. FIG. 4b illustrates an example flow process 405 for serving and/or rendering a web page as shown by the example client 110 and server 130 of FIG. 2 and a user 140 that can provide for rendering and/or serving a web page. Although process 405 of FIG. 4b is described with reference to FIG. 2 and is associated with some steps initially referenced in FIG. 3b, the process 405 is not limited to such configurations and processes and can be applied to other systems, configurations, and processes.

As shown in FIG. 4b, user 140 may provide a URL 403 or other identifier of a web page to client 110. The URL may be provided via an input device 216 of client 110 such as a keyboard. The URL may be provided to the client 110 by an input device 216 such as a mouse, by selecting a URL or a hyperlink of a web page that is being displayed to a user. A URL may additionally be provided in the form of a rerouted link from another URL.

Following the receipt of a URL or other indicator of a web page, the web browser 222 of client 110 requests the web page 413 from server 130. The server 130 then identifies a cutpoint based on a maximum number of rules for an individual style sheet 423 based on the web browser 222 requirements or other criteria. Alternatively, the process of identifying may be performed prior to the request of the web page, and may be provided with the style sheet. The web page is then provided 433 to the web browser 222. The web browser 222 then begins rendering the web page 443. Based on the content of the web page, the web browser 222 then requests a CSS 453 from server 130, and server 130 provides the CSS including the identified cutpoint 463 to the web browser 222. The web browser 222 and style sheet splitting module 224 then split the style sheet into a plurality of derived style sheets based on the cutpoint 473. The splitting of the style sheet may be performed based on instructions, such as code, that is provided by the web page. The web browser 222 then completes the rendering of the web page 483 and provides the web page 493 for display on an output device 214 of client 110. User 140 is thus provided the web page via output device 214.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject technology can be implemented as sub-parts of a larger program while remaining distinct software aspects of the subject technology. In some implementations, multiple software aspects can also be implemented as separate programs. Finally, any combination of separate programs that together implement a software aspect described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

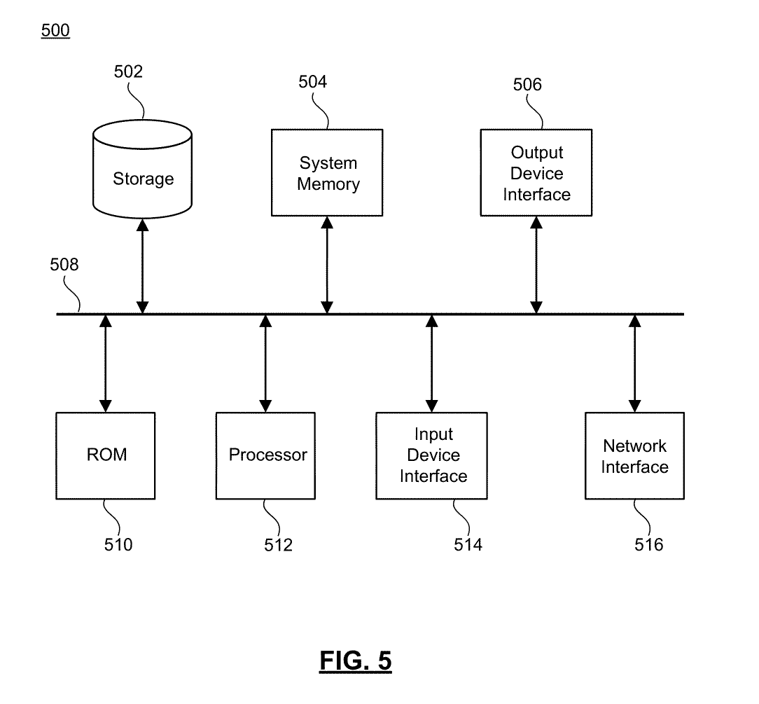

FIG. 5 conceptually illustrates an electronic system with which some implementations of the subject technology are implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject technology. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject technology use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as a random access memory. System memory 504 stores some of the instructions and data that the processor needs at runtime. In some implementations, the processes of the subject technology are stored in system memory 504, permanent storage device 502, and/or ROM 510. For example, the various memory units include instructions for providing for rendering and/or serving a web page in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers such as a local area network (“LAN”), a wide area network (“WAN”), or an Intranet, or a network of networks, such as the Internet. Any or all components of electronic system 500 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for rendering a web page, the method comprising:
requesting a style sheet from a server;
receiving the style sheet in a response from the server;
identifying, by a client device, a cutpoint associated with the style sheet by generating a cutpoint location based on contents of the style sheet;
splitting the style sheet into a plurality of derived style sheets based on the identified cutpoint; and
formatting the web page based on the plurality of derived style sheets.

2. (canceled)

3. The method of claim 1, wherein the cutpoint is identified as a character offset within the style sheet.

4. The method of claim 1, wherein the cutpoint is not placed directly in front of a nested rule within the style sheet.

5. The method of claim 1, wherein the cutpoint is identified so as not to exceed a maximum number of rules per derived style sheet for the web browser.

6. The method of claim 1, wherein a plurality of cutpoints are identified.

7. The method of claim 1, wherein for each derived style sheet of the plurality of derived style sheets, any set of nested rules in the derived style sheet is a complete set of nested rules in the derived style sheet.

8. A computer-implemented method for serving a web page, the method comprising:
identifying, by a client device, a cutpoint associated with a style sheet based on a maximum number of rules for a web browser by generating a cutpoint location based on contents of the style sheet;
sending the web page to the web browser in response to a web page request from the web browser, wherein the web page includes code capable of causing the web browser to request the style sheet; and
sending the style sheet and the identified cutpoint to the web browser in a response to a style sheet request,
wherein the code included in the web page is further capable of causing the web browser to split the style sheet into a plurality of derived style sheets based on the identified cutpoint and format the web page based on the plurality of derived style sheets.

9. The method of claim 8, further comprising:
writing the cutpoint to a header of the response to the style sheet request.

10. The method of claim 8, wherein the cutpoint is identified as a character offset within the style sheet.

11. The method of claim 8, wherein the cutpoint is not placed directly in front of a nested rule within the style sheet.

12. The method of claim 8, wherein a plurality of cutpoints are identified.

13. The method of claim 8, wherein for each derived style sheet of the plurality of derived style sheets, any set of nested rules in the derived style sheet is a complete set of nested rules in the derived style sheet.

14. A system for rendering a web page, the system comprising:
one or more processors; and
a memory containing processor-executable instructions that, when executed by the one or more processors, cause the system to:
request a style sheet from a server;
receive the style sheet in a response from the server;
identify, by a client device, a cutpoint associated with the style sheet by generating a cutpoint location based on contents of the style sheet, wherein the cutpoint is identified as a character offset within the style sheet;
split the style sheet into a plurality of derived style sheets based on the identified cutpoint; and
format the web page based on the plurality of derived style sheets.

15. The system of claim 14, wherein the cutpoint is identified from a header of the response received from the server with the style sheet.

16. The system of claim 14, wherein the cutpoint is not placed directly in front of a nested rule within the style sheet.

17. The system of claim 14, wherein the cutpoint is identified so as not to exceed a maximum number of rules per derived style sheet for the web browser.

18. The system of claim 14, wherein a plurality of cutpoints are identified.

19. The system of claim 14, wherein for each derived style sheet of the plurality of derived style sheets, any set of nested rules in the derived style sheet is a complete set of nested rules in the derived style sheet.

20. A non-transitory machine-readable storage medium comprising machine-readable instructions that when executed by one or more processors provide a method for serving a web page, the method comprising:
identifying an indicator associated with a style sheet by generating a cutpoint location based on contents of the style sheet, wherein the indicator is associated with a variation of the style sheet for a web browser;
sending a web page to the web browser in response to a web page request from the web browser, wherein the web page includes code capable of causing the web browser to request the style sheet; and
sending the style sheet and the identified indicator to the web browser in a response to the style sheet request,
wherein the code included in the web page is further capable of causing the web browser to re-write rules of the style sheet into a derived style sheet based on the identified indicator and format the web page based on the derived style sheet.

21. (canceled)

22. The non-transitory machine-readable storage medium of claim 20, wherein a plurality of indicators are identified.

23. The method of claim 1, wherein the cutpoint is identified from a header of the response received from the server with the style sheet.

24. The non-transitory machine-readable storage medium of claim 20, further comprising writing the indicator to a header of the response to the style sheet request.
